(19) United States
(12) Patent Application Publication
(10) Pub. No.: US 2010/0123776 A1
(43) Pub. Date: May 20, 2010

(54) SYSTEM AND METHOD FOR OBSERVING AN INDIVIDUAL'S REACTION TO THEIR ENVIRONMENT

(75) Inventors: Dean Martin Wydeven, Appleton, WI (US); Herb Flores Velazquez, Neenah, WI (US); Brian James Ludka, Neenah, WI (US)

Correspondence Address: Christopher M. Goff (27839);ARMSTRONG TEASDALE LLP, ONE METROPOLITAN SQUARE, SUITE 2600, ST. LOUIS, MO, 63102, US

(73) Assignee: KIMBERLY-CLARK WORLDWIDE, INC., Neenah, WI (US)

(21) Appl. No.: 12/273,472

(22) Filed: Nov. 18, 2008

(51) Int. Cl. H04N 7/18

(52) U.S. Cl. 348/77; 348/E05.022

(57) ABSTRACT

Methods and systems are provided for observing and recording images of an individual and the individual's reactions to their environment. A facial image capture device is mounted for movement with the individual and is oriented to capture images of the individual's facial region. An environment image capture device is mounted for movement with the individual and is oriented to capture images of the individual's environment. Images of the individual's face and environment are stored on an image storage medium.

### BACKGROUND

The present invention relates generally to systems and methods for observing an individual, and more particularly to such systems and methods for observing an individual's reaction to their environment—for example, as the individual performs an activity.

Many benefits are derived from conducting market research to obtain consumer-related information. Examples include developing new products or features and evaluating how they are received by individuals. Other benefits include using the information to improve product ergonomics, usability, and document customer routines.

One aspect of market research involves analyzing the interactions and reactions of individuals to products. Researchers can determine which products are favorably received by an individual and are therefore more likely to be purchased by other, similarly situated individuals. For example, different types of product packaging are often subjected to market research to determine a particular type of packaging that was well-received by individuals.

One difficulty encountered with obtaining information from individuals is that while they can provide information as to what they know and remember, often they do not accurately or truthfully recall the information. Even though individuals may not have a deceptive intent, their verbal responses to requests for information are often not reflective of their true emotions and reactions regarding a product for a variety of reasons.

To aid in addressing this shortcoming, researchers often capture images of the individual interacting with the product. A common method of analyzing the reaction and interaction of individuals with products is to place concealed cameras in a retail shopping environment. The interactions of individuals with products can then be recorded and observed by researchers, and the individuals later questioned about their reactions to the products. However, as discussed above the individuals' responses to the questions are often not reliable. The placement of the cameras is not ideal as well, since they are placed in fixed, static locations and are unable to capture images from the perspective of the individuals.

Other methods utilize a camera mounted on the individual to record images from the individual's perspective. One such system and method is described in co-assigned U.S. Pat. No. 7,168,804 (Velazquez) entitled VISION SYSTEM AND METHOD FOR OBSERVING USE OF A PRODUCT BY A CUSTOMER and issued Jan. 30, 2007, the entire disclosure of which is incorporated herein by reference. The recorded images are analyzed by researchers and the individual is likewise later questioned about their reaction to viewed products. This method requires dependence on the oft-unreliable responses from the individual in gauging their reaction to the viewed products, leading to unsatisfactory results. The method also includes recording audio along with the images, thereby permitting the individual to provide a running commentary. These systems still rely on the individual to accurately and honestly verbalize their reactions to the product and therefore can suffer many of the shortcomings on non-audio systems and methods.

There is a therefore a need for an observation system and method that facilitates the observation of an individual during the individual's observation of his or her environment such as during the performance of an activity.

### SUMMARY

According to a first aspect, a method of observing the reaction of an individual to the individual's environment is provided. The method comprises mounting a facial image capture device on the individual for movement with the individual and orienting the facial image capture device to capture images of the individual's face. An environment image capture device is mounted on the individual for movement with the individual and the environment image capture device is oriented to capture images of the individual's environment. The facial image capture device is operated to capture at least one image of the individual's face. The environment image capture device is operated to capture at least one image of the individual's environment corresponding generally to the at least one image of the individual's face during the observation by the individual of the individual's environment. The at least one image of the individual's face is stored on an image storage medium. The at least one image of the individual's environment is stored on at least one of the image storage medium on which the at least one image of the individual's face is stored and an image storage medium separate from the image storage medium on which the at least one image of the individual's face is stored.

According to another aspect, a system for observing an individual's reaction to the individual's environment is provided. The system comprises a facial image capture device mounted to an article to be at least one of worn and carried by the individual for movement with the individual. The facial image capture device is oriented relative to the article to capture images of the individual's face upon the article being worn or carried by the individual. An environment image capture device is mounted on an article to be at least one of worn and carried by the individual for movement with the individual. The environment image capture device is oriented relative to the article to capture images of the individual's environment upon the article being worn or carried by the individual. At least one storage medium is provided for storing images of the individual's face and the images of the individual's environment.

Other objects and features will be in part apparent and in part pointed out hereinafter.

### BRIEF DESCRIPTION OF THE DRAWINGS

FIG. 1 is a perspective view of one embodiment of a system for observing an individual's reaction to their environment with the system being donned by an individual;

FIG. 2 is a front elevation thereof;

FIG. 3 is a perspective view of a mounting arm of the system of FIG. 1;

FIG. 4 is a perspective view of another embodiment of a system for observing an individual's reaction to their environment with the system being donned by an individual; and

FIG. 5 is a depiction of an individual in a retail shopping environment and donning the system of FIG. 1.

Corresponding reference characters indicate corresponding parts throughout the drawings.

### DETAILED DESCRIPTION

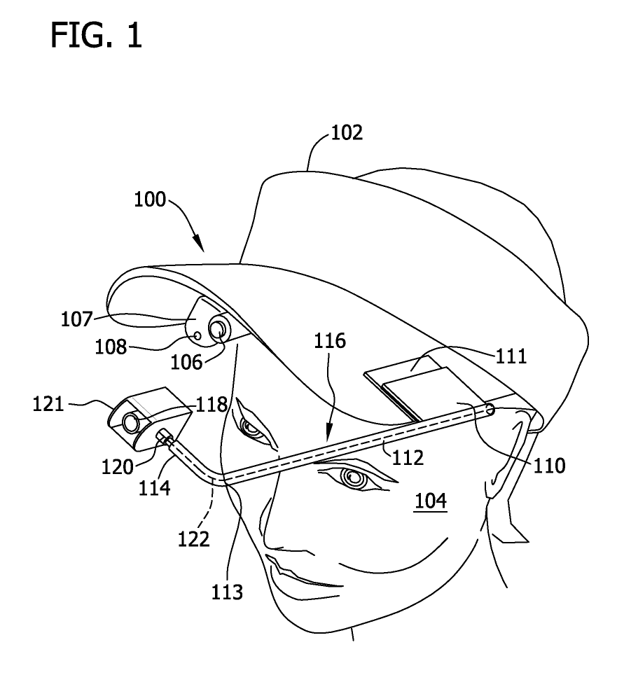

Referring now to the drawings and in particular to FIG. 1, one embodiment of a system for observing an individual's reaction to their environment is generally designated by reference numeral 100. The system 100 generally comprises a facial image capture device 118 (also broadly referred to herein as a first image capture device), and an environment image capture device 106 (also broadly referred to herein as a second image capture device), and may but need not necessarily further comprise an audio capture device 108. In the illustrated embodiment, the system 100 is suitably mounted on the individual carrying out the observation, such as during the performance of an activity, for movement with the individual. The term “mounted” as used in reference to the system 100 being mounted on the individual means secured to, supported by or otherwise carried by the individual during a period of observation.

For example, in the embodiment of FIG. 1 the system 100 may further comprise an article 102 to be worn by the individual during an observation period. The article may be any suitable article worn by individuals such as, without limitation, a hat or visor as illustrated in FIG. 1, a shoulder harness, a head band, arm band or leg band, a waist belt, glasses (including sunglasses), a pin or button, an ear piece, a backpack, purse, briefcase, shirt, pants, vest, jacket, coat, shoes, or other suitable article that may be worn or otherwise carried or supported by the individual during observation of the individual, and combinations of the above. Most suitably, the system 100 is disposed (e.g., mounted, carried or otherwise supported) by an article 102 worn on the individual's head (including, for example the wearer's face) for conjoint movement with the individual's head during observation.

The facial image capture device 118 of the illustrated embodiment is suitably disposed on the article 102 (e.g., the visor in the embodiment of FIG. 1) with the environment image capture device 106 also being disposed on the same article. It is understood, however, that the facial image capture device 118 and the environment image capture device 106 may be disposed on different articles worn by the individual to be observed without departing from the scope of this invention.

The facial image capture device 118 is in one embodiment mounted on the article 102 by suitable mounting structure 116 (broadly, first mounting structure) that allows the facial image capture device 118 to be sufficiently oriented to capture images of all or part of the individual's face during observation of the individual. As one example, in the illustrated embodiment the mounting structure 116 comprises a mounting arm 113 mounted on the article 102 and supporting the facial image capture device 118. In particular, the facial image capture device 118 is mounted on a free end of the arm 113. But the facial image capture device may be mounted elsewhere along the arm 113 and remain within the scope of this invention.

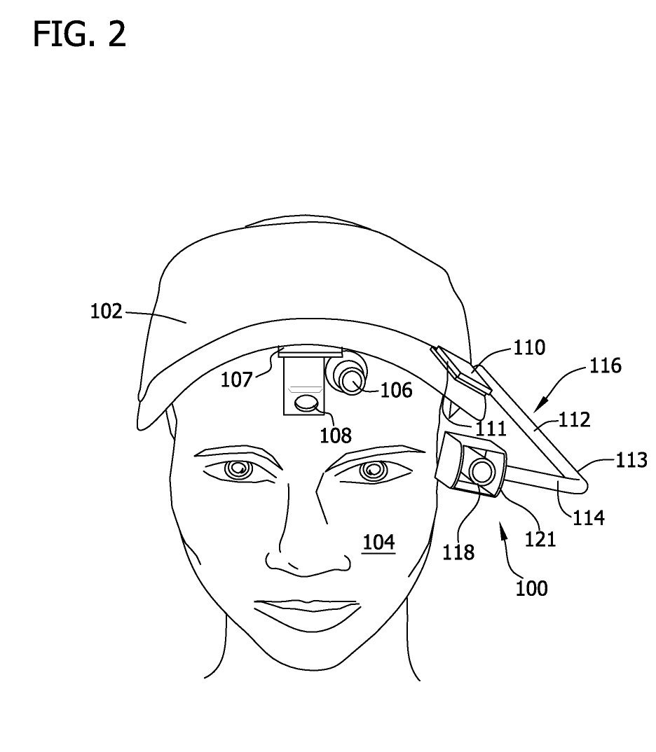

The illustrated mounting arm 113 comprises an elongate extension (first) member 112 mounted on the article and extending outward of the article to a distal end of the extension member. In some embodiments such as that illustrated in FIGS. 1-3, the mounting arm 113 may further comprise a support (second) member 114 connected to the extension member 112 such as at or adjacent the distal end thereof (away from the article 102) and extending at an angle relative to the extension member. In the illustrated embodiment the support member 114 is generally rigidly connected to the extension member 112, with an angle relative to the extension member of about 90 degrees. More particularly, the support member 114 is formed integrally with the extension member 112, although it may instead be formed separate from the extension member and connected thereto by suitable a suitable permanent or releasable connection.

It is contemplated, however, that the support member 114 may be adjustably connected to the extension member 112 such that the support member is adjustably moveable relative to the extension member, pivotally (rotationally) and/or translationally, to adjust the position and orientation of the facial image capture device 118 relative to the individual's face. In other embodiments, the support member 114 and/or the extension member 112 is suitably flexible, i.e., bendable, to permit adjustment of the facial image capture device 118 relative to the individual's face. In such an embodiment, the support member 114 may be formed separate from and connected to the extension member 112, or the support member and the extension member may be formed as a single piece. It is also contemplated that the support member 114 may be angled other than 90 degrees relative to the extension member 112 without departing from the scope of this invention.

As depicted in FIG. 1, the support member 114 is substantially shorter in length than the extension member 112 of the mounting arm 113. In one particularly suitable embodiment, the support member is sized relative and oriented relative to the extension member to position the facial image capture device 118 generally laterally central of the individual's face. However, it is understood that the relative lengths of the support member 114 and extension member 112 may be other than as illustrated without departing from the scope of this invention.

In the embodiment of FIG. 1, the mounting structure 116 further comprises a rotatable coupling 120 mounted on or adjacent a distal end of the support member 114 (which defines the free end of the mounting arm 113). The facial image capture device 118 is suitably mounted on this coupling 120. More particularly, a suitable shield 121 (e.g., a housing) is mounted on the coupling 120 and the facial image capture device 118 is disposed within the shield. It is understood, however, that the shield 121 may be omitted. The rotatable coupling 120 further permits rotation (broadly, orientation) of the facial image capture device 118 relative to the individual's face.

The mounting structure 116 may further comprise a suitable securement system for securing the mounting structure and facial image capture device 118 to the individual and more suitably to the article 102 worn by the individual. In the embodiment illustrated in FIG. 1, the securement system comprises corresponding hook and loop fastener panels 110, 111 with one fastener panel 111 being secured to the article 102 such as by bonding, adhesive, mechanical fastening system or other suitable securement technique, and the corresponding fastener panel 110 secured to the proximal end of the extension member 112. Such an arrangement provides for releasable attachment of the facial image capture device 118 (e.g., along with the mounting arm 113) from the article. It is understood that other suitable securement systems may be used to secure the mounting structure 116 on the article 102, such as without limitation snaps, clasps, clips, mechanical fasteners, and the like.

Alternatively, the mounting structure 116 may be secured to the article 102 by a more permanent securement technique, such as by thermal or pressure bonding, adhesive or other suitable attachment technique. In other embodiments, the mounting structure 116 may be formed integrally with the article 102, or secured at least in part within the article. It is also contemplated that the facial image capture device 118 may be secured directly to the article 102 without the use of mounting structure 116, or it may be secured at least in part within the article and remain with the scope of this invention.

The environment image capture device 106 is suitably mounted on the individual, more suitably on an article worn by the individual, and even more suitably on the same article 102 on which the facial image capture device 118 is mounted. Mounting structure 107 (broadly, second mounting structure) for the environment image capture device 106 may be releasably secured to the article 102, such as, without limitation, by hook and loop fasteners, clips, snaps, mechanical fasteners or other suitable securement systems. In other embodiments, the mounting structure 107 for the environment image capture device 106 may be secured to the article 102 via a more permanent securement, such as by thermal or pressure bonding, adhesive or other suitable attachment. Alternatively, the mounting structure 107 may be formed integrally with the article 102, or it may be disposed at least partially within the article. The mounting structure 107 may be adjustable to permit adjustment of the orientation of the environment image capture device 106 relative to the article 102 and more suitably relative to the individual, although such adjustability need not be provided to remain within the scope of this invention. In other embodiments, the environment image capture device 106 may be secured directly to the article 102 such that the mounting structure 107 may be omitted, or the environment image capture device may be disposed at least partially within the article.

As illustrated in FIG. 1, the mounting structure 107 and environment image capture device 106 are suitably mounted on the article 102 at a location that is generally laterally (transversely) centered between the individual's eyes and is oriented to face outward away from the individual to capture images of the environment observed by the individual, such as in the field of view of the individual regardless of the direction in which the individual's head moves. However, the environment image capture device 106 may be located anywhere on the individual without departing from the scope of this invention.

The mounting structure 107 supporting the environment image capture device 106 on the article 102 also mounts the audio capture device 108 on the article. In other embodiments, the audio capture device 108 may be mounted on the article by structure (not shown) other than the mounting structure 107 for the environment image capture device 106. The audio capture device 108 may also be mounted on the individual other than at the same general location as the environment image capture device 106, such as on the mounting structure 116 for the facial image capture device or at a another location that may be nearer to the individual's mouth.

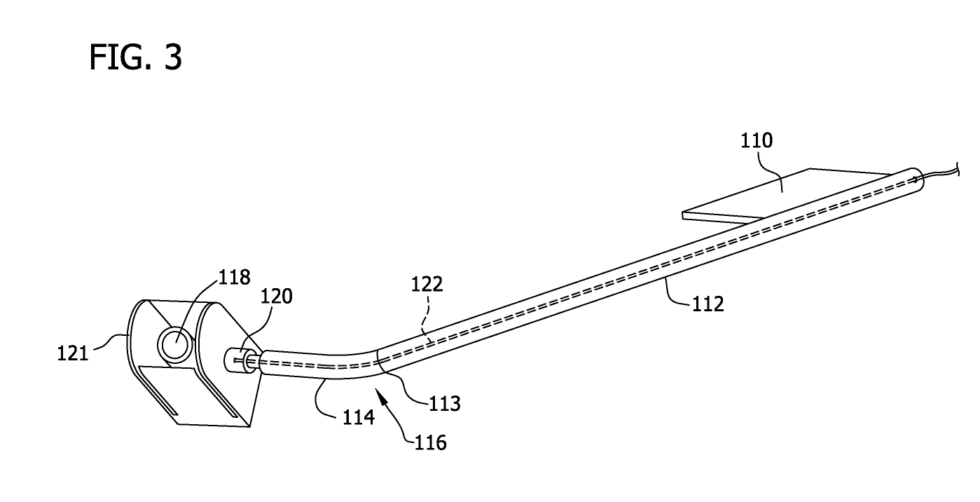

As illustrated in FIG. 3, in one suitable embodiment the extension member 112 of the mounting structure 116 for the facial image capture device 118 is tubular, having an interior channel to permit the routing of wiring 122 (including video cabling or other suitable cabling) therethrough. The wiring 122 allows the transmission of signals corresponding to the images captured by the facial image capture device 118 to an image storage medium (not shown) for storing images capture during observation of the individual. The wiring 122 may also be used by the facial image capture device to receive signals from a remote source. For example, while the facial image capture device 118 may be manually controlled for operation thereof, as well as or alternatively for adjusting the orientation thereof, it is contemplated that the device may be automatically or remotely controlled such as by a wired control (not shown) held by the individual or controlled by a remote source, or by a wireless control. A suitable locking mechanism (not shown) may also be provided, such as on mounting structure 116, to lock the facial image capture device 118 at a desired orientation following adjustment of such orientation.

Additional wiring (not depicted) may be routed from the environment image capture device 106 to an image storage medium (not shown) and/or from the audio capture device to a suitable audio storage medium. Operation and/or orientation adjustment of the environment image capture device 106 may be manual or it may be automated such as by a remote control, either independent of or the same as the control used for the facial image capture device 118.

Examples of suitable image capture devices for use as the facial image capture device 118 and the environment image capture device 106 include, without limitation, a charge couple device or similar image sensor device, such as a digital camera, digital video camera, analog video camera, or a film camera. The facial image capture device 118 may be of the same type as the environment image capture device 106, or of a different type. Examples of suitable image and/or audio storage media include, without limitation: hard disk drives, optical disk drives, random access memory (RAM), magnetic recording tape, or any other storage media operable to store information generated by the image and audio capture devices 106, 108, and 118. The image storage medium for storing images capture by the facial image capture device 118 is in one embodiment separate from the image storage medium for storing images captured by the environment image capture device 106. It is understood, however, that a common storage medium may be used to concurrently store images from the image capture devices 118, 106.

In other embodiments, wiring for any one or more of the facial image capture device 118, the environment image capture device 106 and the audio capture device 108 may instead, or additionally, be routed within the article 102. Alternatively, signals may be delivered to and/or transmitted by the image capture devices 106, 118 and audio capture device 108 wirelessly without departing from the scope of this invention. The wireless communication may be conducted over a wireless network, such as a wide area network (WAN), Bluetooth, infrared, cellular, or a radio frequency communication network.

The system 100 may further include one or more power supplies (not shown) for operating the image capture devices 106, 118 and/or audio capture device 108. For example, a separate power supply may be mounted on (e.g., supported or carried by) the individual for each operating device 106, 118, 108, or a single power supply may provide power to all of these devices. It is contemplated that the power may be supplied to the image capture devices 106, 118 and/or audio capture device 108 through the same or separate wiring (e.g., wiring 122) through signals are sent to and received from the respective devices.

It is also contemplated that the facial image capture device 118, the environment image capture device 106, or both, may deliver a signal to one or more remote monitors (not shown) so that images captured by the respective devices may be viewed by a person (other than the individual being observed) remote from the individual during the observation period.

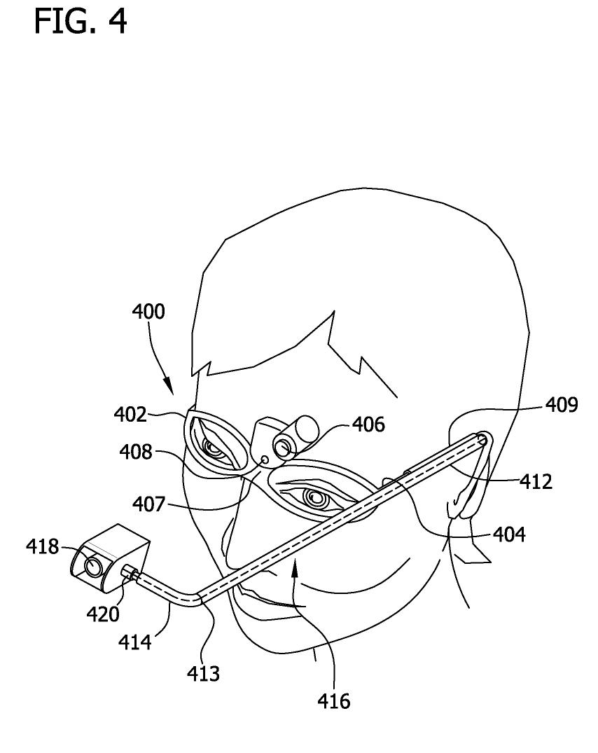

FIG. 4 illustrates another embodiment of a system, generally designated at 400, for observing an individual's reaction to their environment. In this embodiment, an article 402 on which the system 400 is mounted comprises a pair of eyeglasses worn by the individual. A facial image capture device 418 is mounted on the eyeglasses 402 by suitable mounting structure 416 that includes substantially the same mounting arm 413 as that of the mounting structure 116 of FIGS. 1-3, with the mounting arm comprising an extension (first) member 412 mounted on the eyeglasses 402 and extending outward of the eyeglasses to a distal end of the extension member, and in some embodiments further comprising a support (second) member 414 connected to the extension member such as at or adjacent the distal end thereof and extending at an angle relative to the extension member. It is contemplated that in one embodiment the extension member 412 of the mounting arm 412 may be formed integral with the one eyeglasses frame extension 404 without departing from the scope of this invention. The mounting structure 416 of this embodiment also further comprises a rotatable coupling 420 mounted on or adjacent a distal end of the support member 414 (which defines the free end of the mounting arm 413) in the same manner as in the embodiment of FIGS. 1-3.

As illustrated in FIG. 4, the mounting arm 413 of this embodiment, and in particular, the extension member 412, is connected to one of the frame extensions 404 of the eyeglasses 402 through the use of clips, snaps, or other suitable mounting structure. In the embodiment depicted in FIG. 4, for example, a clip 409 connects the frame extension 404 to the extension member 412 of the mounting arm 413. The environment image capture device 406 and the audio recording device 408 are mounted on a bridge piece 407 of the eyeglasses 402 by clips, snaps, or other suitable mounting structure.

As in the embodiment of FIGS. 1-3, the facial image capture device 418 of the embodiment of FIG. 4 is oriented to capture images of the individual's face, while the environment image capture device 406 is oriented to capture images of the individual's environment. The audio capture device 408 captures audio of the individual and/or the individual's environment. Further construction and operation of the observation system 400 of the embodiment of FIG. 4 is substantially the same as the system 100 of FIG. 1.

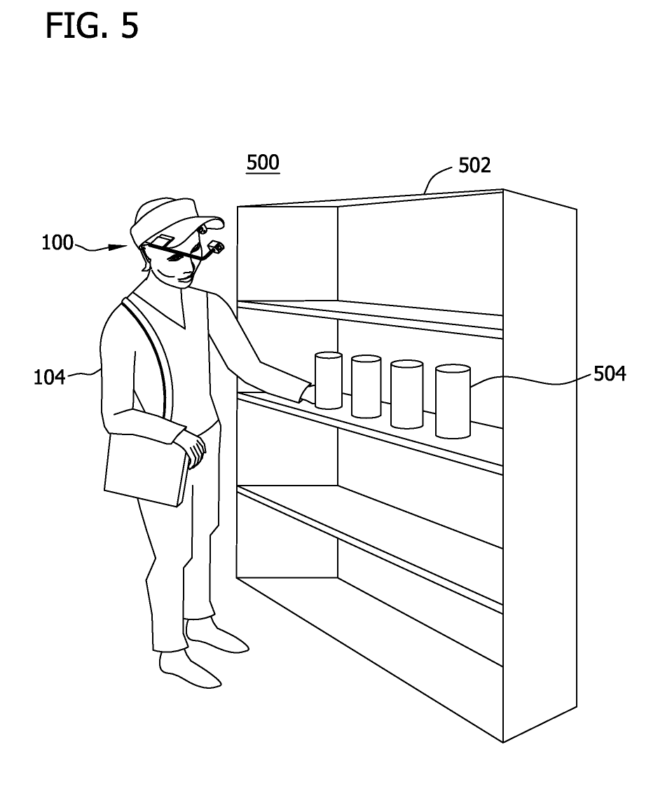

FIG. 5 illustrates one embodiment of the system of FIGS. 1-3 in operation to observe an individual's reaction to their environment. In particular, the illustrated embodiment is of an individual 104 donning the article 102 and observation system 100 of FIGS. 1-3 while observing a retail product display 502. The retail product display 502 is similar to that found in any number of retail stores to display a plurality of products 504. Different brands of products are often displayed next to each other in the retail product display 502, but similar types of products are often grouped together.

The retail product display 502 in some embodiments may be an actual product display in a retail shopping establishment. Retail shopping establishments may include, by way of example only, supermarkets, clothing retailers, electronics retailers, general merchandise retailers, or home improvement retailers. In other embodiments, the retail shopping environment may be a simulated environment, constructed for the purpose of conducting market research or studying an individual's reactions to such an environment. The simulated environments are replicas of retail shopping environments or other environments that an individual may encounter. Other environments may include, without limitation, a home, an office, factory or other place of work, a test facility or other location.

In other embodiments, not shown, the individual's environment may comprise a particular product or products that the individual is using and/or evaluating. In each of these embodiments, the environment image capture device 106 captures images of the individual's environment as viewed by the individual, i.e., as the individual's head and more particularly the individual's line of sight changes the environment image capture device will move with the individual's head to capture such a sight change—e.g., to see provide an indication of what the individual is looking at or holding. The facial image capture device 118 captures images of the individual's facial expressions (reactions) to the environment being encountered by the individual.

In operation of the observation according to one embodiment of a method of observing an individual's reaction to their environment (with particular reference to use of the system 100 of FIGS. 1-3), a facial (first) image capture device 118 is mounted on an individual for movement with the individual. This mounting may occur by placing the article 102 on the individual and then mounting the facial image capture device 118 on the article, or by mounting the device on the article first and then placing the article on the individual. Alternatively, the facial image capture device 118 may be mounted directly to the individual.

The facial image capture device 118 is oriented (either before mounting the device on the individual, or more suitably after such mounting) to capture images of the individual's face while observing the individual's environment. Orienting the facial image capture device 118 to capture images of the individual's face includes adjusting the device so that when an image is captured it includes at least a portion of the individual's face. More suitably the captured image includes at least the individual's eyes, eye brows, forehead, nose, cheeks and mouth. The entire face of the individual may in some embodiments be included in the captured image, or the device may be oriented so as to capture only a region of the individual's face. For instance, the device may be oriented to capture only the region of the individual's face surrounding their eyes without departing from the scope of this invention.

Adjustment of the orientation of the facial image capture device may be performed manually, or remotely by a suitable wired or wireless control. It is also contemplated that the image quality (e.g., zoom, focus, etc.) of images captured by the facial image capture device may be adjusted manually or by remote control, and may be adjusted generally when the orientation adjustment is performed or at a different time such as prior to or even during the observation period.

An environment (second) image capture device 106 is also mounted on the individual. The device 106 may be mounted on the same article 102 as the facial image capture device, a different article than that on which the facial image capture device is mounted, or directly to the individual. Mounting of the environment image capture device 106 may be performed after placing the article 102 on the wearer, or it may be mounted on the article prior to placement of the article on the wearer. It is also understood that the environment image capture device 106 may be mounted on the individual prior to or after mounting the facial image capture device 118 on the individual.

The environment image capture device 106 is oriented to capture images of the individual's environment. The individual's environment may be any environment viewable by an individual, but in some particularly suitable embodiments the environment may comprise a retail shopping environment, whether actual or simulated. In other embodiments the individual's environment may comprise one or products or images to be observed by an individual. More suitably, the individual's environment is that encountered while the individual performs an activity such as, without limitation, evaluating a particular product, viewing a retail environment, performing a work-related operation and/or walking through a retail environment.

The method may further include preparing instructions for the individual on how to use the system 100 (e.g., how to operate and use the image capture devices 106, 118 and audio capture device 108), training the individual on how to use the system 100, obtaining information from the individual relating to observing the performance of an activity by the individual using the system 100, and/or training other individuals to perform the same activity using information obtained from observing the performance of the activity by a first individual. The mounting and/or orientation steps described previously may be performed in response to the prepared instructions and/or training.

Training individuals on how to use the system 100 may include bringing the individuals to a training facility to receive instruction on using the system. The individuals may then take the system 100 with them to perform an activity while operating the system at some other location. The system 100 is then returned to the facility at which point the individual may be debriefed to the provide feedback relating to use of the system. Training could also be performed in an environment where an individual normally performs an activity, such as a home, office, factory, retail environment, etc. The nature of the training will depend on the application but may include demonstration of all aspects of using the system.

With the image capture devices 106, 118 in place, operation of the devices is initiated (e.g., either manually or by remote control) as the individual performs an activity so that images of the individual's face and images of the individual's environment are concurrently captured during the performance of the activity. For example, in one particularly suitable embodiment, images are captured by the respective image capture devices 106, 118 as a function of time and/or frame during observation by the individual, and/or relative to the time at which operation of the respective image capture device is initiated.

In one embodiment, the image capture devices 106, 118 are suitably operated to capture images at a substantially similar rate such that any phase difference between the image or frame sequence between the images captured by the respective devices is relatively small. However, it is understood that the rate of image capture of the respective image capture devices 106, 118 may be different from each other without departing from the scope of this invention. Audio bites from the audio recording device (when present) are also captured concurrently with image capturing by the image capture devices 106, 118.

During the observation period, images captured by one or both of the image capture devices 106, 118 may be delivered to a remote monitor or monitors where a person conducting the observation can monitor what the subject individual is seeing, what the individual's reactions are to what is being seen, and can monitor whether the activity is being performed according to a predetermined protocol.

The captured images of the individual and of the individual's environment are also stored on image storage media such as any of the image storage media described previously. The image storage media may be carried by the individual, such as part of the respective image capture device 106, 118, or separate therefrom and carried elsewhere by the individual. In this manner, the individual may don the system 100 and operate the system while performing an activity at a remote site (i.e., remote from a test facility) and then return the system to the test facility where the stored images may be viewed and analyzed. In other embodiments, the image storage media may be remote from the individual without departing from the scope of this invention. The same configurations apply to audio storage media used to capture audio from the audio capture device 108 during performance of the activity by the individual.

Each of the captured images from the respective image capture devices 106, 118 is suitably encoded with information describing a frame number and/or a point in time that the image was captured relative to the time at which the observation was initiated and/or relative to the frame number at which operation of the respective device was initiated. This information may be encoded as metadata either internally within the captured image, or externally in another file stored on the image storage media. This information aids in the subsequent synchronizing of the captured images by providing an effective time stamp for each captured image.

To review and analyze the individual's reaction to his/her environment during the performance of an activity, the stored images of the individual's face and of the individual's environment are synchronized together, such as on a split screen monitor or other suitable visual media. Alternatively, the stored images may be synchronized and stored in a new storage media, with the synchronized images then being displayed on a monitor. For example, a corresponding pair of captured images that appears on a monitor may include a captured image of the individual's face and a captured image of the individual's environment at a corresponding time (e.g., time or frame) during the period in which the individual was performing the activity. In a system 100 where the image capture devices capture images at different capture rates, corresponding pairs of captured images may be captured at different points in time. To synchronize the stored images for viewing in such an instance, some of the images captured and stored by a slower capture rate device 106, 118 may be duplicated (or some of the images captured and stored by a faster capture rate device may be discarded).

The images of the individual's face and individual's environment are then analyzed to determine the individual's facial expressions as a measure of the individual's reaction to the environment encountered by the individual. For example, if the individual's facial expression is a frown or scowl; it is likely that the individual is dissatisfied or unhappy with something in their environment. To the contrary, when the facial expression is a smile or grin; the individual is likely satisfied with something in their environment. Other facial expressions include without limitation a raised eyebrow, lip movement, eye movement and the like.

The emotions indicated by the individual's facial expressions can then be compared against the corresponding images of the individual's environment. This provides a likely indication of the trigger of the individual's emotions. For instance, if the captured image of the individual's environment is that of a particular product and the individual's emotions determined from the corresponding images of the individual's face indicate that the individual is intrigued or interested; a reliable deduction is that the product provoked the intrigue or interest expressed by the individual's facial expression. Alternatively, when the captured images of the individual's facial expression indicate dissatisfaction and the corresponding captured images of the environment include a particular product; the likely deduction is that the individual is not satisfied with the product.

The facial expressions exhibited by an individual during the performance of an activity are a more accurate indicator of their “moment-in-time” reaction to a product because they often occur instinctively, without thought by the individual. The same can not be said for audible responses spoken by the individual during and more particularly after encountering the environment. The individual may “filter” their audible or written responses, either consciously or subconsciously, for a variety of reasons. For example, the individual may say they like a product because they believe that is the answer that would please a person asking the question. The individual may do this subconsciously, without thinking, out of a desire to please authority figures, e.g., the person asking the question. As the individual's facial expressions occur instinctively, “filtering” is unlikely to occur.

In some embodiments, the synchronized images of the individual's face and of the individual's environment may be viewed simultaneously by a third party, such as a market researcher. The third party can analyze these images to determine the likely emotions exhibited by the individual in response to their environment. The third party is then able to make a correlation between the activities being engaged in by the individual and the emotions generated in response thereto.

Other embodiments of the method may utilize computerized facial recognition techniques to analyze the captured images of the individual's face to determine the facial expressions exhibited by the individual. The facial expressions can then be compared against a correlation table that defines emotions associated with facial expressions.

The audio captured by the audio recording device (e.g., a microphone or similar device) is also synchronized with the images of the individual's face and individual's environment.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above products without departing from the scope of the invention, it is intended that all matter contained in the above description and shown in the accompanying drawings shall be interpreted as illustrative and not in a limiting sense.

What is claimed is:

1. A method of observing the reaction of an individual to the individual's environment, the method comprising:
mounting a facial image capture device on said individual for movement with the individual, said mounting step comprising orienting the facial image capture device to capture images of the individual's face;
mounting an environment image capture device on said individual for movement with the individual, said mounting step comprising orienting the environment image capture device to capture images of the individual's environment;
operating the facial image capture device to capture at least one image of the individual's face;
operating the environment image capture device to capture at least one image of the individual's environment corresponding generally to the at least one image of the individual's face during the observation by said individual of said individual's environment;
storing the at least one image of the individual's face on an image storage medium; and
storing the at least one image of the individual's environment on at least one of the image storage medium on which the at least one image of the individual's face is stored and an image storage medium separate from the image storage medium on which the at least one image of the individual's face is stored.

2. The method of claim 1 wherein mounting the facial image capture device on said individual for movement with the individual comprises mounting the facial image capture device on an article worn by the individual.

3. The method of claim 1 wherein mounting the environment image capture device on said individual for movement with the individual comprises mounting the environment image capture device on an article worn by the individual.

4. The method of claim 3 wherein mounting the environment image capture device on said individual for movement with the individual comprises mounting the environment image capture device on the same article on which the facial image capture device is mounted.

5. The method of claim 1 wherein the step of operating the facial image capture device and the step of operating the environment image capture device comprises operating each of said devices generally concurrently during performance of an activity by the individual.

6. The method of claim 1 wherein the step of operating the environment image capture device comprises operating said environment image capture device to capture at least one image of the individual's environment corresponding generally in time to the at least one image of the individual's face.

7. The method of claim 1 wherein the step of mounting the facial image capture device on the individual for movement with the individual comprises mounting the facial image capture device on the individual at a location that is generally opposed to the individual's face.

8. The method of claim 1 wherein the step of mounting the facial image capture device on the individual comprises mounting support structure on an article worn by the individual, and mounting the facial image capture device on the support structure.

9. The method of claim 8 wherein the step of orienting the facial image capture device comprises adjusting the facial image capture device relative to the individual to capture images of the individual's face.

10. The method of claim 1 wherein the step of operating the facial image capture device comprises at least one of initiating operation of the facial image capture device and controlling operation of the facial image capture during image capture from a location remote from the individual.

11. The method of claim 10 wherein the step of operating the environment image capture device comprises at least one of initiating operation of the environment image capture device and controlling operation of the environment image capture during image capture from a location remote from the individual.

12. The method of claim 1 wherein the step of operating the facial image capture device to capture at least one image of the individual's face comprises operating the facial image capture device to capture a plurality of images of the individual's face, said images being captured sequentially for a time period of observation by the individual of the individual's environment, the step of operating the environment image capture device to capture at least one image of the individual's environment comprises operating the environment image capture device to capture a plurality of images of the individual's environment, said images of the individual's environment being captured sequentially throughout substantially the same time period of observation by the individual of the individual's environment.

13. The method of claim 12 further comprising synchronizing the stored images of the individual's environment with the stored images of the individual's face over said time period of observation.

14. The method of claim 13 further comprising viewing said synchronized images of the individual's environment and images of the individual's face to analyze the individual's facial expressions in response to the individual's environment during the time period of observation.

15. The method of claim 14 wherein the viewing step comprises simultaneously viewing the synchronized images.

16. The method of claim 1 further comprising capturing audio spoken by the individual during observation by the individual of the individual's environment, and storing the audio on an audio storage medium.

17. A system for observing an individual's reaction to the individual's environment, the system comprising:
a facial image capture device mounted on an article to be at least one of worn and carried by the individual for movement with the individual, said facial image capture device being oriented relative to said article to capture images of the individual's face upon the article being worn or carried by the individual;
an environment image capture device mounted on an article to be at least one of worn and carried by the individual for movement with the individual, said environment image capture device being oriented relative to said article to capture images of the individual's environment upon the article being worn or carried by the individual;
at least one storage medium for storing said images of the individual's face and said images of the individual's environment.

18. The system of claim 17 wherein the facial image capture device and the environment image capture device are mounted on the same article.

19. The system of claim 17 wherein the facial image capture device is mounted on an article to be worn on the individual's head, the environment image capture device also being mounted on an article for wear on the individual's head.

20. The system of claim 17 further comprising mounting structure for mounting the facial image capture device on the article, said mounting structure being secured to the article and supporting the facial image capture away from the article for positioning in generally opposed relationship with the individual's face upon wearing or carrying of the article by the individual.

21. The system of claim 20 wherein the mounting structure is adjustable relative to the article to adjust the orientation of the facial image capture device relative to the individual.

22. The system of claim 17 wherein the environment image capture device is of the same type of device as the facial image capture device.

23. The system of claim 22 wherein each of said facial image capture device and said environment image capture device comprises a charge couple device.

24. The system of claim 17 wherein the at least one storage medium is separate from the facial image capture device and the environment image capture device, said facial image capture device and said environment image capture device being in electrical communication with the at least one storage medium for delivering said facial images and said environment images to said at least one storage medium.

25. The system of claim 24 wherein the electrical communication between the facial and environmental image capture devices and the at least one storage medium comprises a wireless communication.

26. The system of claim 17 wherein the at least one storage medium comprises a first storage medium for storing images captured by the facial image capture device, and a second storage medium, separate from said first storage medium, for storing images captured by the environment image capture device.

27. The system of claim 17 further comprising an analytical device capable of synchronizing the stored images of the individual's environment with the stored images of the individual's face such that each of said environment images correspond with a respective facial image captured at the substantially the same point in time.

28. The system of claim 27 further comprising a display in communication with the synchronizing device to simultaneously display the synchronized environment images and facial images.

29. The system of claim 17 further comprising an audio capture device for capturing audio present in the individual's environment, and a storage medium for storing said captured audio.
